(19) United States
(12) Patent Application Publication
(10) Pub. No.: US 2026/0225378 A1
(43) Pub. Date: Aug. 6, 2026

(54) Thermal Printhead with Thermoelectric Cooling Module

(71) Applicant: Zebra Technologies Corporation, Lincolnshire, IL (US)

(72) Inventor: Angel B. Rosales, Port Hueneme, CA (US)

(73) Assignee: Zebra Technologies Corporation, Lincolnshire, IL (US)

(21) Appl. No.: 19/044,934

(22) Filed: Feb. 4, 2025

(51) Int. Cl. B41J 2/375; B41J 2/335; B41J 2/355

(52) U.S. Cl. CPC B41J 2/375; B41J 2/3359; B41J 2/355

(57) ABSTRACT

A thermal printhead with Peltier cooling module may be provided by a thermal printhead assembly, comprising a circuit board defining a media facing side opposed to an anterior side, a plurality of heating elements disposed on a media facing side of the circuit board; and a thermoelectric heat pump, having a heat absorbing surface and a heat radiating surface electrically coupled to each other, the heat absorbing surface coupled to the anterior side of the circuit board; wherein, in response to an electric signal flowing through the thermoelectric heat pump, the thermoelectric heat pump is configured to absorb heat emitted by the plurality of heating elements via the heat absorbing surface, and radiate the heat via the heat radiating surface, such that a temperature of the circuit board remains below a predetermined temperature threshold.

### BACKGROUND

Thermal printheads produce excess heat during operation, and increasing a media feed rate and throughput of a thermal printer increases the excess heat produced, which can cause overheating the thermal printer, and burning of the print media.

### SUMMARY

In an embodiment, the technology of the present disclosure may be provided by a thermal printhead assembly, comprising a circuit board defining a media facing side opposed to an anterior side a plurality of heating elements disposed on a media facing side of the circuit board; and a thermoelectric heat pump, having a heat absorbing surface and a heat radiating surface electrically coupled to each other, the heat absorbing surface coupled to the anterior side of the circuit board. In response to an electric signal flowing through the thermoelectric heat pump, the thermoelectric heat pump is configured to absorb heat emitted by the plurality of heating elements via the heat absorbing surface, and radiate the heat via the heat radiating surface, such that a temperature of the circuit board remains below a predetermined temperature threshold.

In a variation of this embodiment, the thermoelectric heat pump is a Peltier module.

In a variation of this embodiment, the heat absorbing surface of the thermoelectric heat pump is bonded to the anterior side of the circuit board with a thermal adhesive.

In a variation of this embodiment, the heat radiating surface of the thermoelectric heat pump comprises, or is coupled to, a heatsink.

In an embodiment, the technology of the present disclosure may be provided by a method of forming a thermal printhead assembly, comprising providing a base unit comprising a printhead housing; installing, on the base unit, a circuit board defining a media facing side and an anterior side, the circuit board comprising a plurality of heating elements disposed on the media facing side; and installing, on the circuit board, a thermoelectric heat pump having a heat absorbing surface that is electrically coupled to a heat radiating surface, such that the heat absorbing surface is coupled to the anterior side of the circuit board.

In a variation of this embodiment, the thermoelectric heat pump is a Peltier module.

In a variation of this embodiment, the thermoelectric heat pump is installed by bonding the heat absorbing surface to the anterior side of the circuit board with a thermal adhesive.

In a variation of this embodiment, the method further includes coupling a heatsink to the heat radiating surface of the thermoelectric heat pump.

In an embodiment, the technology of the present disclosure may be provided by a media processing device, comprising a housing, a printhead assembly operatively coupled to the housing, the printhead assembly comprising a printhead comprising a circuit board defining a media facing side opposed to an anterior side, a plurality of heating elements disposed on a media facing side of the circuit board, and a thermoelectric heat pump, having a heat absorbing surface and a heat radiating surface electrically coupled to each other, the heat absorbing surface coupled to the anterior side of the circuit board. In response to an electric signal flowing through the thermoelectric heat pump, the thermoelectric heat pump is configured to absorb heat emitted by the plurality of heating elements via the heat absorbing surface and radiate the heat via the heat radiating surface. The media processing device further includes a control system configured to control the electric signal.

In a variation of this embodiment, the media processing device further includes a thermal sensor configured to measure a temperature of the printhead, or the temperature of a portion of the printhead, and to output temperature data to the control system.

In a variation of this embodiment, the control system is configured to increase or decrease an amperage of the electric signal delivered to the thermoelectric heat pump responsive to the temperature data from the thermal sensor.

In a variation of this embodiment, the thermoelectric heat pump is a Peltier module.

In a variation of this embodiment, the heat absorbing surface of the thermoelectric heat pump is bonded to the anterior side of the circuit board with a thermal adhesive.

In a variation of this embodiment, the heat radiating surface of the thermoelectric heat pump comprises, or is coupled to, a heatsink.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a media processing device, according to embodiments of the present disclosure.

FIG. 2 illustrates a thermal printhead of the media processing device, according to embodiments of the present disclosure.

FIG. 3 illustrates a thermoelectric cooling module, according to embodiments of the present disclosure.

FIG. 4 illustrates a modified thermal printhead including the thermoelectric cooling module of FIG. 3 coupled to the thermal printhead of FIG. 2, according to embodiments of the present disclosure.

FIG. 5 illustrates a detailed view of a portion of the media processing device of FIG. 1, including the modified thermal printhead of FIG. 4, according to embodiments of the present disclosure.

FIG. 6 illustrates a the modified printhead of FIG. 4, coupled with a finned heatsink, according to embodiments of the present disclosure.

FIG. 7 illustrates a flowchart of a method for forming a thermal printhead, according to embodiments of the present disclosure.

FIG. 8 illustrates a logic circuit as may be included in the media processing device of FIG. 1, according to embodiments of the present disclosure.

### DETAILED DESCRIPTION

Various improvements have been made in thermal printers and thermal printheads with regard to the speed at which such devices can operate, as well as with regard to throughput. Several issues arise when increasing feed rate in thermal printers. Fundamentally, in order to print a print design on a media element, heating elements of a thermal printhead must be energized to reach or exceed a high temperature threshold to print a dark (e.g., colored) pixel and remain below the high temperature threshold when printing a light pixel (e.g., by de-energizing or not energizing a heating elements) or vice versa. In order to remain below the high temperature threshold when energizing one or more of the heating elements to printing dark pixels, which may be adjacent to heating elements that de-energized printing light pixels in the print design, the temperature of the energized heating element(s) must be within a particular range of the high temperature threshold, such that should the heating element be directed to print a light pixel, ambient cooling is sufficient to reduce the temperature of the previously energized and now de-energized heating element so as not to print or partially print a dark pixel within a predetermined time frame. When increasing feed rate, or generally increasing throughput, the electrical input to the heating elements of the thermal printhead increases over a given period of time, while available cooling time decreases. This can result in heating elements lacking an appropriate amount of time to cool, which may result in inadvertent printing and burning of the print media (or ribbon for transfer thermal printing). As such there is a need for devices and methods for removing excess heat from thermal printheads when increasing throughput of a thermal printer.

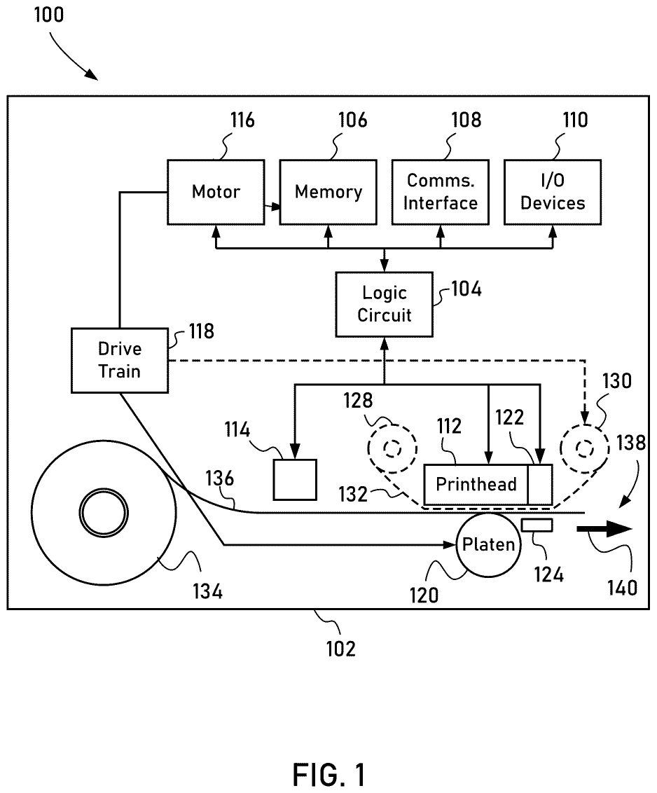

FIG. 1 illustrates a block diagram of an example media processing device 100 (e.g., printer, thermal printer), in accordance with embodiments of the present disclosure. The media processing device 100 can include a housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, a platen roller 120, a thermoelectric module 122, and a temperature sensor 124. The printhead 112 and the platen roller 120 can form a nip. In some embodiments, e.g., for thermal transfer printing, the media processing device 100 can include a ribbon supply spindle 128 and a ribbon take up spindle 130 for supporting an ink ribbon 132. For direct thermal embodiments, the media processing device 100 can be devoid of the ribbon supply spindle 128, the ribbon take-up spindle 130, and the ink ribbon 132. The housing 102 can also be configured to contain a media supply 134. As an example, the housing 102 can include a media chamber to store the media supply 134 as it is consumed by the media processing device 100. The logic circuit 104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

The thermoelectric module or thermoelectric heat pump 122 is operatively and/or thermally coupled to or integrally formed with the printhead 112 to dissipate heat generated by the heating elements from the printhead 112. The thermoelectric module can be selectively energized to facilitate active heat removal based on a flow of electric current and can be selectively de-energized (no electric current flow) to facilitate passive heat removal. In some examples, the thermoelectric module 122 can be selective energized to facilitate active heating based on a flow of electric current (e.g., can heat the printhead 112).

The temperature sensor 124 is positioned proximate to the printhead 112 to measure a temperature of the printhead 112 (or the burn line of the printhead 112) or provide a proxy for the temperature of the printhead 112 (or the burn line of the printhead 112).

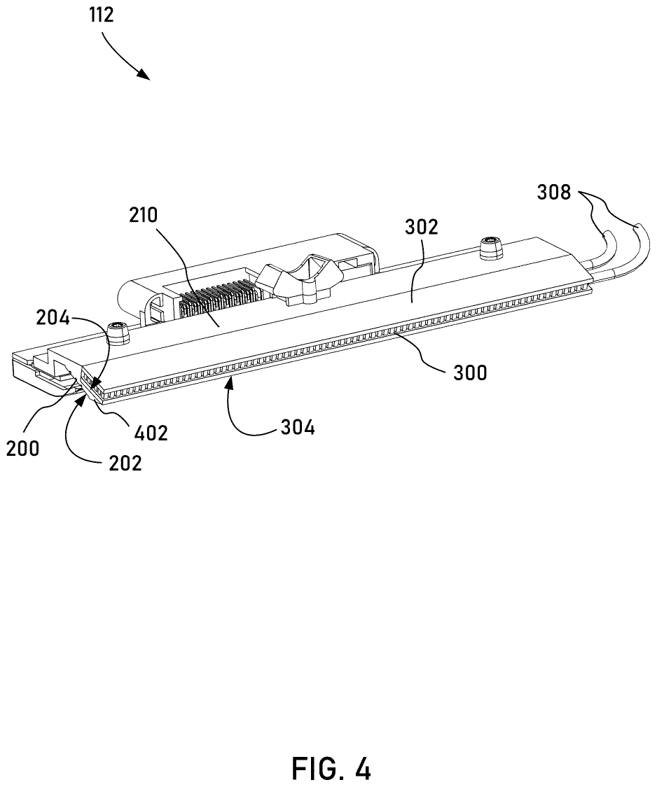

The logic circuit 104 of the media processing device 100 can be operatively coupled to the memory 106, the communications interface 108, the I/O devices 110, the printhead 112, the radiofrequency encoder/reader 114, the motor 116, and/or the thermoelectric module 122. The platen roller 120 can be driven by the motor 116 via a drive train 118 to rotate the platen roller 120 about an axis of rotation in a first direction (e.g., clockwise in the orientation shown in FIG. 1) to pull the media 136 through the feed path in a direction indicated by arrow 140 and output the media from the media processing device via a media exit 138 formed in the housing 102 and can be driven by the motor 116 via the drive train 118 to rotate the platen roller 120 about the axis of rotation in a second direction (e.g., counterclockwise in the orientation shown in FIG. 4) to retract the media 136 (in an opposite direction than the arrow 140). In one example, the logic circuit 104 can be configured to execute code stored in the memory 106 to perform operations and functions of the media processing device 100, e.g., by communicating with and/or controlling one or more of the components of the media processing device 100. The logic circuit 104 can execute the code stored memory 106 to implement a printing operation or function that controls the motor 116 to rotate the platen roller 120 to feed the media 136 past the printhead 112, controls the printhead 112 to print on the media 136 (either directly or by transferring an ink from a ribbon to the media), controls the RF encoder/reader 114 to encode and/or read radiofrequency circuits (e.g., RFID or NFC tags or inlays) included in or on the media 136, and/or controls an operation of the thermoelectric module 122 to dissipate heat from the printhead 12. For thermal transfer printing, the printable surface of the media 136 is configured to receive a pigment (e.g., resin, wax-resin, etc.) that is transferred from the ink ribbon 132 installed on the ribbon supply and take-up spindles 128 and 130, respectively, via an operation of the printhead 112. For direct thermal printing, the printhead 112 of the media processing device 100 can selectively heat the printable surface of the media 136 triggering a chemical or physical change in a thermally sensitive dye covering at least a portion of the printable surface of the media 136. After printing on the media 136, the media can be further advanced and output from media processing device 100 by the operation of the platen roller 120.

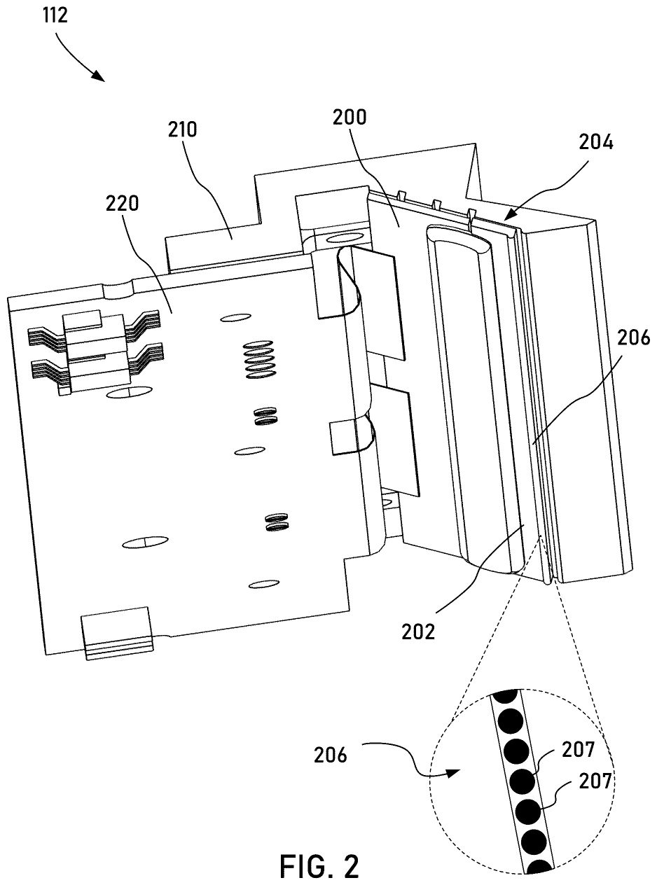

FIG. 2 illustrates an example thermal printhead 112, as may be deployed in the media processing device 100, according to embodiments of the present disclosure.

Generally, the thermal printhead 112 includes a circuit board 200, which defines a burn line 206 including a plurality of heating elements 207 which are configured to print pixels of a print design when supplied with pulses of electrical current (e.g., by the circuit board). The printhead 112 defines a media facing side 202 on which the burn line 206 is disposed, and an opposite, anterior side 204. The circuit board 200 is operatively coupled to a printhead chassis 210, which is generally configured to support the circuit board 200, and to facilitate both mechanical and electrical coupling to other features of the media processing device (e.g., via fasteners or other conventional means of coupling, as well as various types of electrical connectors). The thermal printhead 112 can further include a secondary circuit board 220, which in some examples is operatively coupled (e.g., wired) to the circuit board 200 and in other examples may be integrated with the circuit board 200. The secondary circuit board 220 may contain circuitry that may be spaced away from the burn line or positioned elsewhere for integration purposes. In various examples, one or both of the circuit board 200 and the secondary circuit board 220 may be integrated with the printhead chassis 210.

In some examples, the thermal printhead 112 may be a high speed thermal printhead. Some examples of high speed thermal printheads include the TE3004-ZTZB4W Printhead produced by ROHM Semiconductor of Kyoto, Japan. Use of such high speed thermal printheads introduces new operational challenges. High speed thermal printheads require a greater net input of electric current to the printhead 112 over a given period of time of steady-state operation (e.g., relative to a standard printhead), which in turn results in a greater net output of heat from the thermal printhead 112 over the same given period of time. The increase in heat output may result in overprinting or overburning of the print media, which may decrease print quality. In order to maintain print quality, a number of approaches may be taken.

Firstly, periods of dwell time during the printing process may be increased. Dwell time refers to periods of time during a printing process in which current is not supplied to the heating elements 207, which permits the heating elements 207, and the thermal printhead 112, to ambiently cool. The solution of increasing dwell time is largely viewed as undesirable, as increasing dwell time results in increased printing times, and use of a high speed printhead is typically implemented to decrease print times.

Alternatively, a device or apparatus configured to remove excess heat from the thermal printhead 112 produced during operation may be employed to retain temperatures of the thermal printhead 112 within acceptable ranges. In various examples, such devices may be used to achieve steady state printing at high speeds, or at least reduce the dwell time required to retain temperatures of the thermal printhead 112 within acceptable ranges.

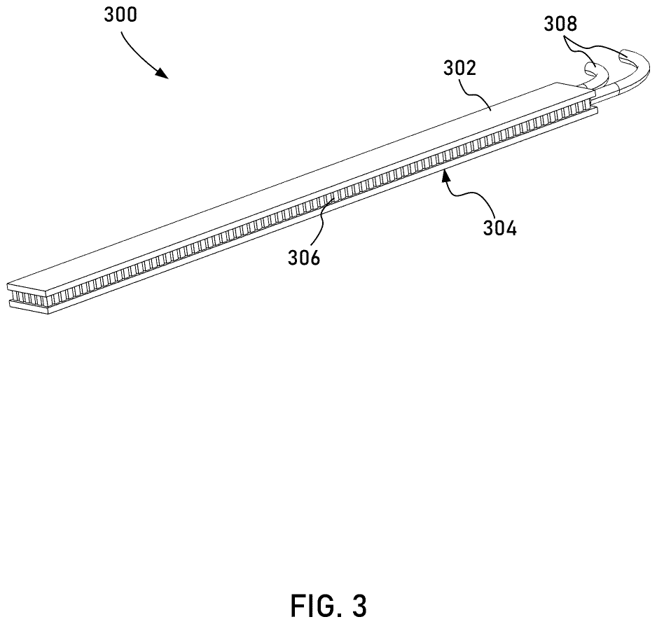

FIG. 3 illustrates a Peltier module 300, which is an example thermoelectric module, or example thermoelectric heat pump, according to embodiments of the present disclosure (e.g., thermoelectric module or thermoelectric heat pump 122 shown in FIG. 1). Generally, as deployed in the embodiments of the present disclosure, the Peltier cooling module 300 is a device configured to remove heat from the thermal printhead 112 produced during operation and to retain temperatures of the thermal printhead 112 within specified ranges.

The Peltier module 300 includes a heat radiating surface 302 opposed to a heat absorbing surface 304. The heat absorbing surface 304 is spaced away from the heat radiating surface 302 by a semiconductor layer 306. The semiconductor layer 306 is operatively coupled to electrical contacts 308, through which an electrical current (e.g., electrical signal) may be selectively delivered to the semiconductor layer 306. When an electrical current is delivered to the semiconductor layer 306, a heat flux is created from the heat absorbing surface 304 to the heat radiating surface 302. In some examples, the heat absorbing surface 304 and the heat radiating surface 302 are reversible, such that the heat radiating surface 302 absorbs heat and the heat absorbing surface 304 radiates heat when the electrical current is reversed. Some examples of Peltier cooling modules include the CP14-51-06-L1-W4.5 Ceramic Plate Series Thermoelectric Coolers produced by Laird Thermal Systems of Durham, North Carolina.

FIG. 4 illustrates a thermal printhead 112 including an embodiment of a thermoelectric module or thermoelectric heat pump, e.g., in the Peltier cooling module 300, installed on the printhead chassis 210 of a thermal printhead 112, according to embodiments of the present disclosure. The Peltier cooling module 300 is configured such that the heat absorbing surface 304 is oriented proximately to the anterior side 204 of the circuit board 200. The printhead chassis 210 may be configured such that the anterior side 204 of the circuit board 200 and the heat absorbing surface 304 of the Peltier module 300 abut one another or are otherwise directly contacting. The Peltier module 300 can be positioned on the anterior side 204 to align with the burn line 206 on the media facing side 202 such that the burn line 206 and the heat absorbing surface 304 are opposingly spaced and separated by the circuit board 200. In some examples, the printhead chassis 210 may be configured such that an intervening portion 402 of the printhead chassis 210 intervenes between the circuit board 200 and the Peltier module 300 (e.g., the Peltier module is indirectly coupled to the circuit board 200), in which case the intervening portion 402 may serve as a structural support for both the Peltier cooling module 300 and the circuit board 200, as well as a thermal transfer medium therebetween.

In various embodiments, an existing printhead chassis 210 may be manufactured or modified such that the Peltier cooling module 300 may be operatively coupled to the printhead 112 in a manner that supports removal of heat from the printhead 112. In some examples, the Peltier cooling module 300 may be secured to the printhead 112 or the printhead chassis 210 by a conventional means of attachment, such as fasteners, adhesives, snap fit geometry, and the like. In some examples, the Peltier cooling module 300 may be bonded or adhered to the printhead 112 or printhead chassis 210 by a thermal adhesive or thermal putty, configured to facilitate heat transfer from the circuit board 200 to the Peltier cooling module 300, while physically retaining the Peltier cooling module 300 to the printhead 112 or printhead chassis 210.

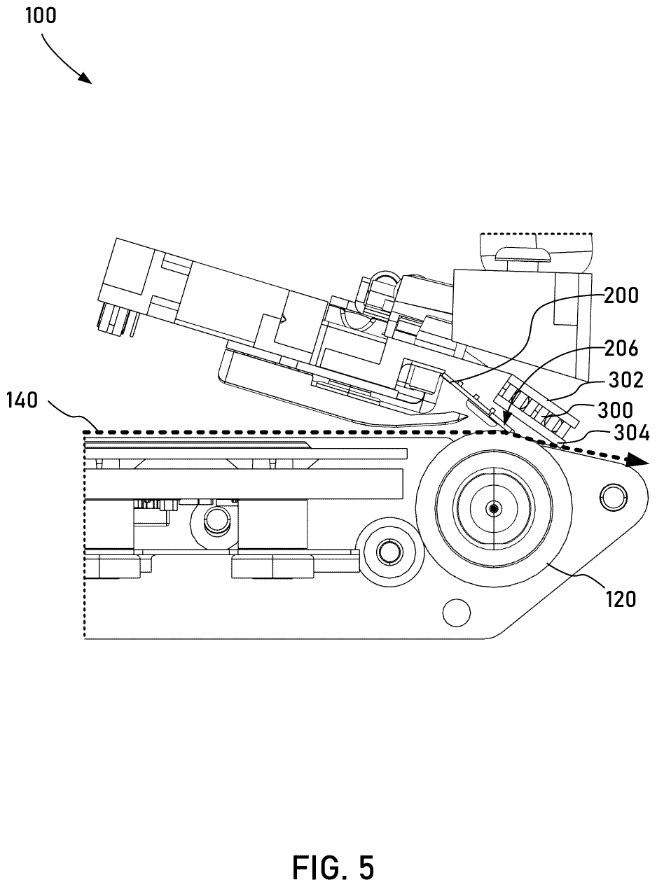

FIG. 5 illustrates a portion of the media processing device 100 including a printhead 112, where the printhead 112 includes an embodiment of a thermoelectric module or thermoelectric heat pump, e.g., in the Peltier cooling module 300, according to embodiments of the present disclosure. A media feed path is defined through the media processing device 100 along the direction indicated by the arrow 140. A nip may be formed between the platen roller 120 and the thermal printhead 112 proximately to the burn line 206.

During operation of the media processing device 100, the heating elements 207 generate excess heat as a byproduct of operation. The Peltier cooling module 300 is configured to absorb a portion of the excess heat through the anterior side 204 of the circuit board 200 (e.g., and in some cases through the intervening portion 402 of the printhead chassis 210) via the heat absorbing surface 304, and when current is delivered to the Peltier cooling module 300, drive the heat from the heat absorbing surface 304 to the heat radiating surface 302 via the Peltier effect.

In various examples, the Peltier cooling module 300 may provide for an increase in media throughput of the media processing device 100 over the course of a printing process. In discussing improvements to print processes, it is understood that any referenced improvements are considered to be relative to a thermal printer configured to operate at a predetermined feed rate which results in a predetermined print quality. The referenced improvements which may be provided by the media processing devices 100 of the present disclosure (e.g., including a Peltier cooling module 300, and in some examples including a high speed thermal printhead) are understood to result in a print quality which is at least the predetermined print quality. Note that feed rate on any thermal printer may simply be increased, however significant decreases in print quality will be observed (e.g., underburning, underprinting), and the object of the present disclosure is to increase net throughput of a thermal printer or media processing device 100 without incurring such decreases in print quality.

Various use cases for the media processing device 100 with the Peltier cooling module 300 may be deployed according to user preferences, such as print media type, volume or quantity of print media to be processed, desired rate of delivery for media elements, and the like.

In a first use case, the media processing device 100 with the Peltier cooling module 300 allow for an increase in steady-state feed rate of the media processing device 100. Of the various use cases discussed herein, increasing the steady-state feed rate of the media processing device 100 incurs the largest cooling load on the Peltier cooling module 300, as cooling is unaided by dwell times. The Peltier cooling module 300 may be selected or configured to account for these larger cooling loads. In some examples, the Peltier cooling module 300 may provide cooling which allows for increases in steady state feed rate of both standard speed printheads and high-speed printheads. In some examples, feed rate may be increased by about 5%, about 10%, about 15%, about 20%, about 25%, about 50%, by about 100% or by more than 100%.

In a second use case, the media processing device 100 with a Peltier cooling module 300 may reduce dwell times during a printing process. In some configurations, large increases in steady state feed rate (e.g., 25% or greater, as a non-limiting example) may overload the cooling capacity Peltier cooling module 300. In such cases, dwell times may be introduced to allow for additional cooling. Preferably, in such examples, the Peltier cooling module 300 reduces dwell times as compared to thermal printers operating at a similar feed rate, such that the net throughput over a printing process of the media processing device 100 with the Peltier cooling module 300 is still increased, despite inclusion of dwell times.

In both the first use case and the second use case, net throughput of media through the media processing device 100 is preferable increased over the course of one or more printing processes.

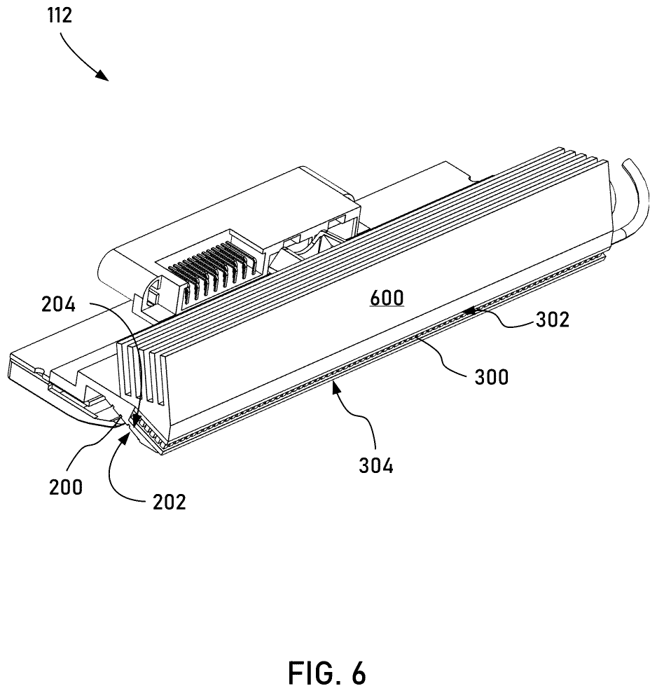

FIG. 6 illustrates the thermal printhead 112 and the Peltier cooling module 300, in which the Peltier cooling module 300 is operatively coupled to a heatsink 600, which is configured to further facilitate dissipation of heat from the heat radiating surface 302 of the Peltier cooling module 300.

According to some embodiments, the heatsink 600 may be included in the media processing device 100. The heatsink can include fins to facilitate removal of heat via convection. Although illustrated as a finned heatsink, the heatsink 600 may take other forms between various embodiments contemplated in the present disclosure.

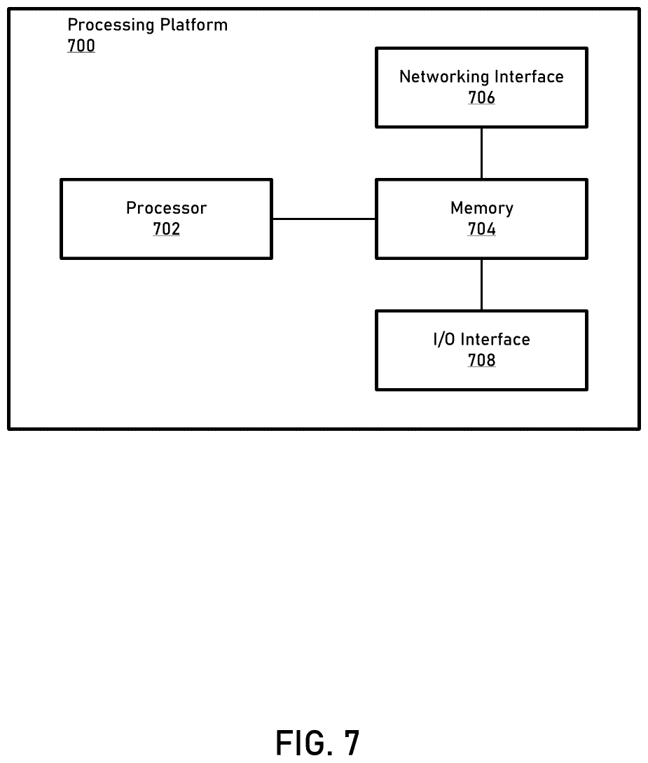

FIG. 7 is a block diagram representative of an example logic circuit capable of implementing, for example, one or more components of the example the logic circuit 104 or, more generally, the media processing device 100 of FIG. 1. The example logic circuit of FIG. 7 is a processing platform 700 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 700 includes a processor 702 such as, for example, one or more microprocessors, controllers, and/or any suitable type of processor. The example processing platform 700 includes memory (e.g., volatile memory, non-volatile memory) 704 accessible by the processor 702 (e.g., via a memory controller). The example processor 702 interacts with the memory 704 to obtain, for example, machine-readable instructions stored in the memory 704 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 700 to provide access to the machine-readable instructions stored thereon.

The example processing platform 700 also includes a network interface 706 to enable communication with other machines via, for example, one or more networks. The example network interface 706 includes any suitable type of communication interface(s) (e.g., wired and/or wireless interfaces) configured to operate in accordance with any suitable protocol(s).

The example, processing platform 700 also includes input/output (I/O) interfaces 708 to enable receipt of user input and communication of output data to the user.

In various examples, the thermal printhead 112 of the media processing device 100 may include a thermal sensor, or thermostat (e.g., temperature sensor 124 shown in FIG. 1), which is configured to measure a temperature corresponding to a temperature of the printhead 112 and transmit temperature data to the processing platform 700 (e.g., via the network interface 706). The processing platform 700 may also provide a connection between the Peltier cooling module 300 and a power supply, such that the processing platform 700 controls the flow of electrical current (e.g., electrical signal) to the Peltier cooling module 30 which drives cooling by the Peltier cooling module 300. In various examples, the processing platform 700 may be configured to increase an amperage of power delivered to the Peltier cooling module 300 when the sensor detects that the temperature of the printhead 112 is in a first temperature range (e.g., high temperature range), or above a predetermined temperature threshold (e.g., high temperature threshold) in order to increase cooling and lower the temperature of the printhead 112. The processing platform may be configured to increase the amperage of the electrical current delivered to the Peltier cooling module 300 where the increase in amperage is proportional to or corresponds to a degree to which the temperature of the printhead 112 exceeds the predetermined temperature threshold. In some examples, the processing platform may be configured to reduce amperage of the electrical current delivered to the Peltier cooling module 300 or cease delivery of current to the Peltier cooling module 300 when the temperature of the printhead 112 is detected to be in a second predetermined range or is below a second predetermined temperature threshold.

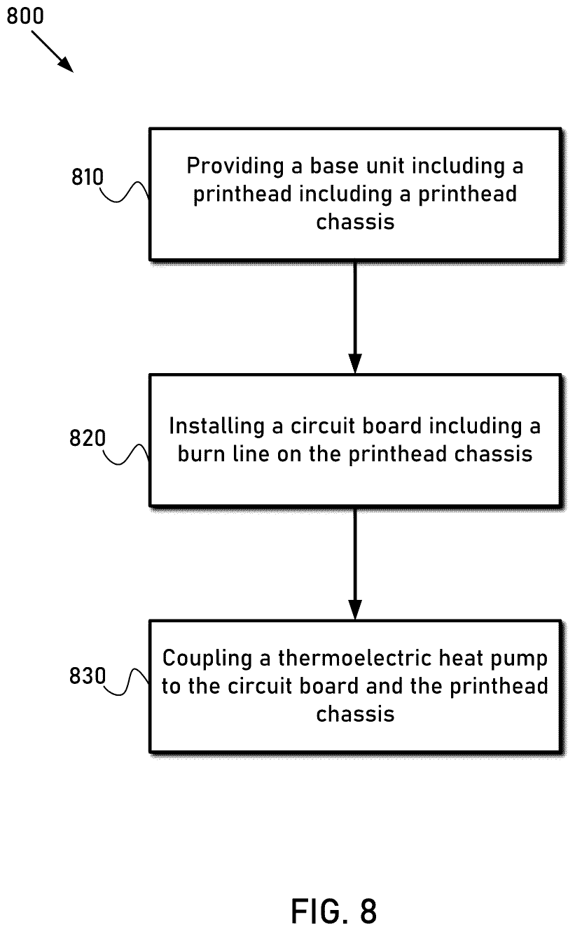

FIG. 8 illustrates a flowchart a method 800 for forming a thermal printhead assembly (e.g., thermal printhead 112, thermal printhead 112 with Peltier cooling module 300) according to embodiments of the present disclosure.

Block 810 describes a step of the method 800 in which a base unit including a thermal printhead assembly is provided, according to embodiments of the present disclosure. The base unit may include a printhead chassis (e.g., printhead chassis 210), and various electrical and mechanical components to support electric connections and mechanical connections to other features of a media processing device (e.g., media processing device 100). A user may manufacture a thermal printhead base unit or otherwise acquire a thermal printhead base unit.

Block 820 describes a step of the method 800 in which a circuit board including a burn line is installed on the printhead chassis of the base unit, according to embodiments of the present disclosure. The circuit board (e.g., circuit board 200) includes a plurality of heating elements (e.g., heating elements 210) configured to impart indicia on print media when a current is delivered to the heating elements. The circuit board may be as described in reference to FIG. 2. The circuit board is operatively coupled to the base unit, such that the base unit supports the circuit board. In some examples, the circuit board may be coupled to the base unit by various conventional means of attachment, such as fasteners and the like. In some examples, one or both of the circuit board and the base unit may be equipped with complimentary snap fit or press fit geometry. The circuit board may define a media facing side and an anterior side. Generally, the media facing side of the is oriented substantially outward form the base unit, so as to affect print media when installed in a media processing device. Coupling the circuit board to the base unit may include attaching one or more electrical connectors so as to provide electrical communication between the base unit and the circuit board.

Block 830 describes a step of the method 800 in which a thermoelectric heat pump is coupled to the circuit board and the printhead chassis, according to embodiments of the present disclosure. The thermoelectric heat pump may be a Peltier cooling module (e.g., Peltier cooling module 300). In various examples, the thermoelectric heat pump may be directly attached to the circuit board, and in other examples the thermoelectric heat pump may be affixed to the base unit in manner that allows for rapid thermal transfer between the circuit board and the thermoelectric heat pump through the base unit. Generally, the thermoelectric heat pump defines a heat absorbing surface and a heat radiating surface. The heat absorbing surface is coupled to the circuit board (either directly or via or the base unit) where the heat absorbing surface is more proximate to the anterior side of the circuit bard than the heat radiating surface. The thermoelectric heat pump is operatively coupled to the circuit board where excess heat emitted by the circuit board in operation is rapidly transferable to the heat absorbing side of the thermoelectric heat pump. The thermoelectric heat pump may be coupled to the circuit board or the base unit by various conventional means of attachment, such as fasteners. In some examples, the thermoelectric heat pump is bonded to the circuit board or base unit via a thermal adhesive, configured to both mechanically support the thermoelectric heat pump and provide rapid thermal conduction thereto.

After the step of block 830 is completed, the method 800 may be concluded.

In various embodiments, the method 800 may be performed to produce the printhead 112 with Peltier cooling module 300 of FIG. 4, the description of which applies to the method 800.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The invention is claimed as follows:

1. A thermal printhead assembly, comprising:
a circuit board defining a media facing side opposed to an anterior side, a plurality of heating elements disposed on a media facing side of the circuit board; and
a thermoelectric heat pump, having a heat absorbing surface and a heat radiating surface electrically coupled to each other, the heat absorbing surface coupled to the anterior side of the circuit board;
wherein, in response to an electric signal flowing through the thermoelectric heat pump, the thermoelectric heat pump is configured to absorb heat emitted by the plurality of heating elements via the heat absorbing surface, and radiate the heat via the heat radiating surface, such that a temperature of the circuit board remains below a predetermined temperature threshold.

2. The thermal printhead assembly of claim 1, wherein the thermoelectric heat pump is a Peltier module.

3. The thermal printhead assembly of claim 1, wherein the heat absorbing surface of the thermoelectric heat pump is bonded to the anterior side of the circuit board with a thermal adhesive.

4. The thermal printhead assembly of claim 1, wherein the heat radiating surface of the thermoelectric heat pump comprises, or is coupled to, a heatsink.

5. A method of forming a thermal printhead assembly, comprising:
providing a base unit comprising a printhead housing;
installing, on the base unit, a circuit board defining a media facing side opposed to an anterior side, the circuit board comprising a plurality of heating elements disposed on the media facing side; and
coupling, to the circuit board, a thermoelectric heat pump having a heat absorbing surface that is electrically coupled to a heat radiating surface, such that the heat absorbing surface is coupled to the anterior side of the circuit board.

6. The method of claim 5, wherein the thermoelectric heat pump is a Peltier module.

7. The method of claim 5, wherein the thermoelectric heat pump is installed by bonding the heat absorbing surface to the anterior side of the circuit board with a thermal adhesive.

8. The method of claim 5, further comprising coupling a heatsink to the heat radiating surface of the thermoelectric heat pump.

9. A media processing device, comprising:
a housing;
a printhead assembly operatively coupled to the housing, the printhead assembly comprising:
a printhead comprising:
a circuit board defining a media facing side opposed to an anterior side, and
a plurality of heating elements disposed on a media facing side of the circuit board, and
a thermoelectric heat pump, having a heat absorbing surface and a heat radiating surface electrically coupled to each other, the heat absorbing surface coupled to the anterior side of the circuit board,
wherein, in response to an electric signal flowing through the thermoelectric heat pump, the thermoelectric heat pump is configured to absorb heat emitted by the plurality of heating elements via the heat absorbing surface, and radiate the heat via the heat radiating surface; and
a control system configured to control the electric signal.

10. The media processing device of claim 9, further comprising a thermal sensor configured to measure a temperature of the printhead, or the temperature of a portion of the printhead, and to output temperature data to the control system.

11. The media processing device of claim 10, wherein the control system is configured to increase or decrease an amperage of the electric signal delivered to the thermoelectric heat pump responsive to the temperature data from the thermal sensor.

12. The media processing device of claim 9, wherein the thermoelectric heat pump is a Peltier module.

13. The media processing device of claim 9, wherein the heat absorbing surface of the thermoelectric heat pump is bonded to the anterior side of the circuit board with a thermal adhesive.

14. The media processing device of claim 9, wherein the heat radiating surface of the thermoelectric heat pump comprises, or is coupled to, a heatsink.
